(19) United States
(12) Patent Application Publication
(10) Pub. No.: US 2016/0319979 A1
(43) Pub. Date: Nov. 3, 2016

(54) Gut Hook Bladed Pipe Slitter

(71) Applicant: Earth Tool Company LLC, Lake Mills, WI (US)

(72) Inventors: Robert F. Crane, Nekoosa, WI (US); Mark D. Randa, Summit, WI (US); Walter George Thompson, Janesville, WI (US)

(21) Appl. No.: 15/139,995

(22) Filed: Apr. 27, 2016

Related U.S. Application Data
(60) Provisional application No. 62/154,365, filed on Apr. 29, 2015.

(51) Int. Cl. F16L 55/165

(52) U.S. Cl. CPC F16L 55/1658

(57) ABSTRACT

An apparatus for replacing an existing pipe. The apparatus comprises a slitting apparatus towed by a wire rope. The apparatus has an elongate body having opposed first and second ends and a hollow region extending end-to-end. A pair of wings is supported on the body. Each wing has a recessed inner surface having a sharpened edge and an outer surface. The outer surface does not have an edge as sharp as the sharpened edge of the recessed inner surface. The sharpened edge slits the existing pipe and the outer surface is positioned to engage any adjacent pipes without causing damage to the adjacent pipe as the apparatus is towed. through the ground.

### CROSS REFERENCE TO RELATED APPLICATIONS

This application claims the benefit of U.S. Provisional Patent Application Ser. No. 62/154,365 filed on Apr. 29, 2015, the entire contents of which are incorporated herein by reference.

### FIELD

The present invention is related to the field of replacing underground utilities and specifically to a system and assembly for slitting an underground utility pipe and installing a new utility pipe in place of the old pipe.

### SUMMARY

The present invention is directed to an assembly comprising an elongate body and a first wing The elongate body has opposed first and second ends and a hollow region extending end-to-end. The first wing is supported on the body. The first wing comprises a recessed inner surface having a sharpened edge and an outer surface having no edge as sharp as the sharpened edge of the recessed inner surface.

The invention is also directed to a system comprising a wire rope, an expander, a rope puller, and an assembly disposed on the wire rope between the expander and rope puller. The wire rope has a first end and a second end. The expander is operatively engaged to the wire rope at its first end. The rope puller is operatively engaged to the wire rope at its second end. The assembly comprises an elongate body and a first wing. The elongate body has opposed first and second ends and a hollow region extending end-to-end The first wing is supported on the body. The first wing comprises a recessed inner surface having a sharpened edge and an outer surface having no edge as sharp as the sharpened edge of the recessed inner surface.

The invention is further directed to an assembly comprising an elongate body and a plurality of wings. The elongate body has opposed first and second ends. The wings are supported on the body. Each wing comprises a recessed inner surface having a sharpened edge configured to cut a pipe and an outer surface having no edge as sharp as the sharpened edge of the inner surface.

### DESCRIPTION OF THE DRAWINGS

FIG. 1 is diagrammatic representation of an underground utility replacement system that uses a pipe slitting assembly, an expander, and a replacement pipe connector.

FIG. 2 is a close-up view of the pipe slitting assembly of FIG. 1 shown partially within an underground pipe.

FIG. 3 is a perspective view of the pipe slitting assembly.

FIG. 4 is a longitudinal sectional view of the pipe slitting assembly of FIG. 2.

FIG. 5 is a sectional view of the expander shown in FIG. 1.

FIG. 6 is a sectional view of the replacement pipe connector shown in FIG. 1.

### BACKGROUND

Pipe slitting is the process of longitudinally separating an existing in situ ductile pipe, expanding the soil surrounding the periphery of the pipe and simultaneously pulling in a replacement pipe. The existing pipe is most often High Density Polyethylene pipe used for natural gas transmission, though various grades of PVC and thermoplastics may be replaced with the assembly and method of the present invention. Replacement of utilities is often done to replace leaking or aged underground pipes and is an alternative to open cut, trenching, or various forms of boring such as horizontal directional drilling or use of pneumatic impact moles.

Pipe replacement systems operate by passing a wire rope through the old pipe from an entry point to an exit point. At the exit point a slitting tool having exposed blades is attached to the wire rope in series with an expander and a towing member. The new or product pipe is attached to the towing member. A rope puller such as a rotary or hand-to-hand winch is connected to the wire rope near the entry point. The winch pulls the wire rope, pipe slitter, expander, towing member, and new pipe through the ground from the exit point to the entry point. The replacement pipe is towed in during this process. Occasionally, the blades of the pipe slitter may accidentally cut or damage an adjacent utility during the pipe slitting process. Thus, there remains a need for improved devices and methods for the replacement of underground pipes. The present invention provides an assembly and method for reducing the likelihood of damage to adjacent utilities during pipe replacement operations.

### DESCRIPTION

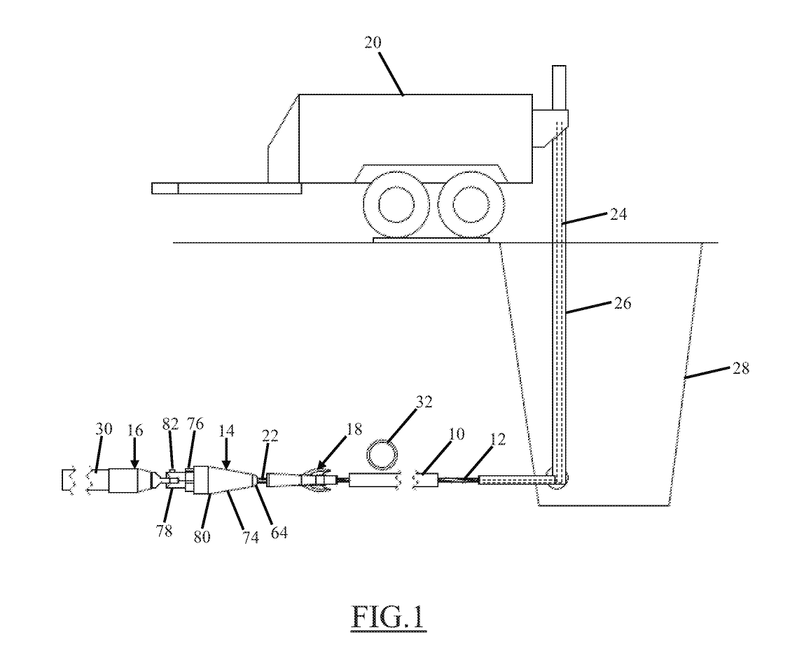

Turning now to the figures, FIG. 1 shows the overall system of the present invention used to slit and replace an underground pipe 10. The system may comprise a wire rope 12, an expander 14, a replacement pipe connector 16, a pipe slitting assembly 18, and a rope puller 20. The wire rope 12 has a first end 22 and a second end 24. The first end 22 of the wire rope 12 is operatively connected to the expander 14. The second end 24 is operatively engaged with the rope puller 20. As depicted in FIG. 1, the wire rope 12 may be partially disposed within a boom 26 that extends from the rope puller into the entry pit 28. The pipe slitting assembly 18 is disposed on the wire rope 12 between the expander 14 and the rope puller 20. The new pipe 30 that is towed in the borehole is connected to the replacement pipe connector 16.

The rope puller 20 may comprise an above-ground rotary or hand-to-hand winch. One such acceptable winch is the Hydroguide® winch manufactured and sold by Hammerhead® Trenchless Equipment. However, one skilled in the art will appreciate that a winch positioned within the entry pit 28 may also be used. One such acceptable winch is the Portaburst® manufactured and sold by Hammerhead® Trenchless Equipment. The winch should be capable of putting the wire rope with sufficient force to pull the pipe slitting assembly 18 and expander 14 through the old pipe 10 and the replacement pipe connector 16 and new pipe 30 through the bore left behind by the expander.

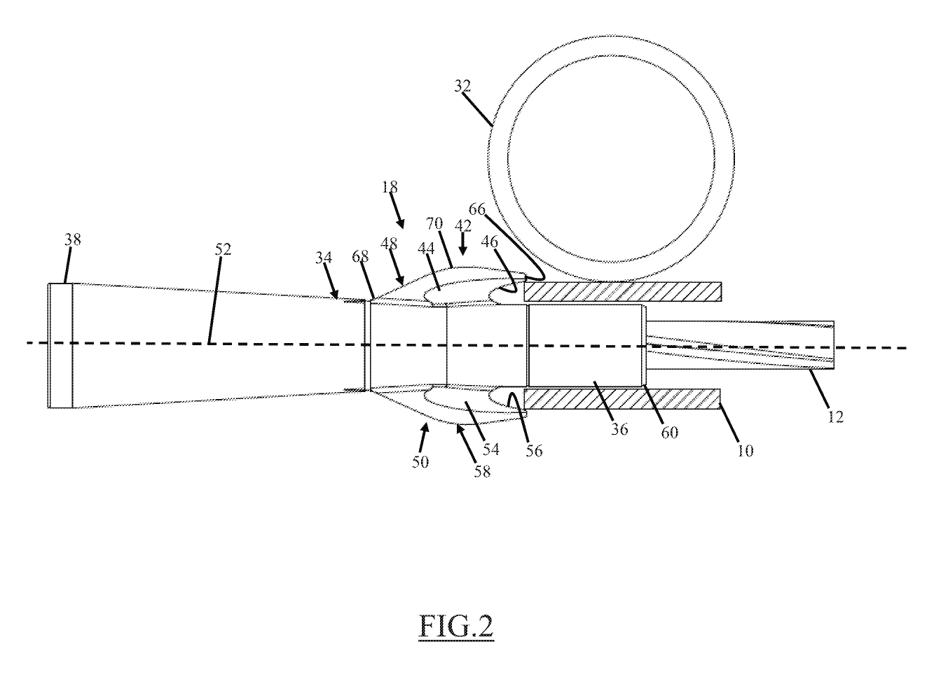

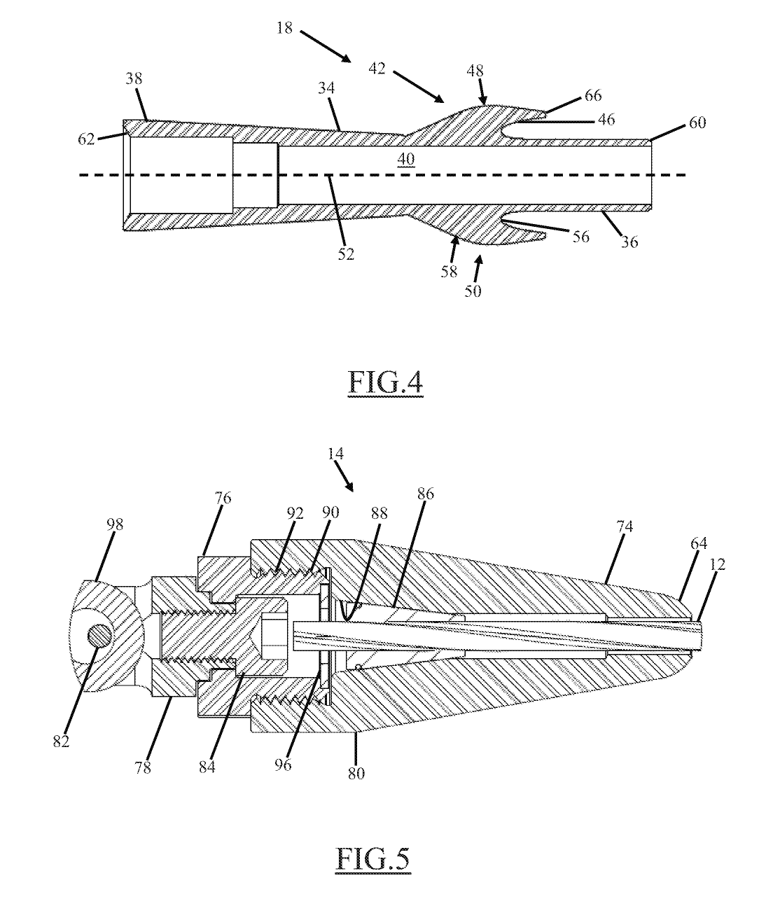

Turning now to FIG. 2, a close-up of the pipe slitting assembly 18 and adjacent pipe 32 is shown. The pipe slitting assembly 18 is shown partially within the old pipe 10 and disposed on the wire rope 12. The adjacent pipe 32 is shown disposed near the old pipe 10. As shown in FIGS. 2 and 4, the assembly 18 comprises an elongate body 34 having opposed first 36 and second ends 38. The assembly also has a hollow region 40 that extends from the first end 36 to the second end 38. A first wing 42 is supported on the body 34. The first wing 42 comprises a recessed inner surface 44 that has a sharpened edge 46. The first wing 42 also has an outer surface 48. The outer surface 48 does not have an edge as sharp as the sharpened. edge 46 of the recessed inner surface 44.

A second wing 50 may be supported on the body 34. The second wing 50 is offset from the first wing 42 about a longitudinal axis 52 of the body 34 by a central angle of 180 degrees. Like the first wing 42, the second wing 50 has a recessed inner surface 54 having a sharpened edge 56. The second wing 50 also has an outer surface 58 that has no edges as sharp as the sharpened edge 56 of the recessed inner surface 54. Both the first wing 42 and the second wing 50 radially project from the body 34 such that both recessed inner surfaces 44 and 54 open towards the first end 36 of the body 34 and will engage the old pipe 10 with their sharpened edges 46 and 56 when pulled to the right in FIG. 2.

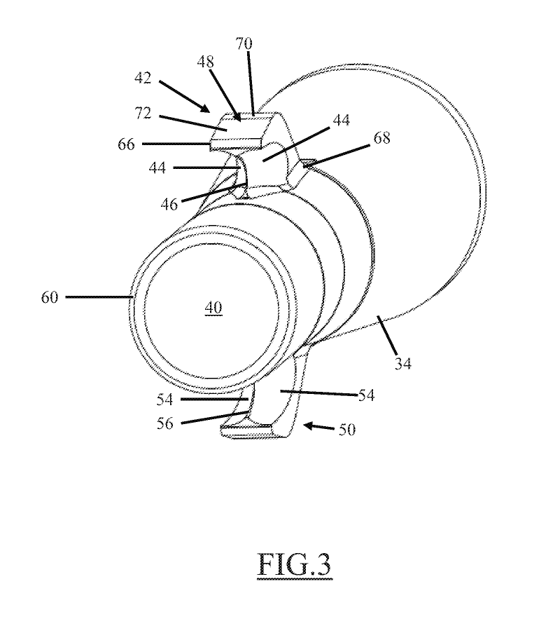

The sharpened edges 46,56 of both wings have a curved profile that appears generally parabolic when viewed from the side as shown in FIGS. 2 and 4. The sharpened edges 46, 56 are formed at the intersection of a pair of concave inner surfaces 44 and 54 (FIG. 3) formed on both sides of the first wing 42 and the second wing 50. As shown in FIG. 2, the sharpened edges 46, 56 engage the old pipe 10 to slit the pipe in half lengthwise. The curved profile of the sharpened edges 46, 56 also functions to pull the pipe toward the body 34 as the pipe is cut. Concave surfaces 44, 54 function to direct the cut halves of the pipe laterally away from the body as the apparatus 18 is pulled further through the ground.

The pipe slitting apparatus 18 described herein is shown with two wings supported on the body 180 degrees apart. However, one skilled in the part will appreciate the apparatus may comprise a plurality of wings supported on the body with each wing comprising a recessed inner surface and an outer surface. Each inner surface has a sharpened edge configured to cut the old pipe. Each outer surface has no edge as sharp as the sharpened edge of the inner surface. Each of the plurality of wings may radially project from the body and may be uniformly spaced about the longitudinal axis 52 of the body 34.

Referring to FIGS. 2-4, the first wing 42 has an outer surface 48 that extends along a curved path from the body 34 to a terminal end 66 at the junction of the outer surface with the sharpened edge 46. As shown in FIG. 2, the outer surface 48 shields the adjacent utility 32 from the sharpened edge 46 of the wing 42 as the apparatus is pulled through the ground to slit the old pipe 10. The outer surface 48 may comprise a base portion 68 that extends from the body 34 and has a width that is approximately equal to the combined width of the recessed inner surfaces 44 and the sharpened edge 46. The base portion 68 extends radially outward from the body 34 to a peak 70 at which the curvature of the outer surface bends back toward the longitudinal axis 52 of the apparatus to define a shield 72 (FIG. 3). The shield 72 is formed to direct the adjacent utility 32 away from the sharpened edge 46 of the wing 42. As shown in FIG. 3, the peak 70 and shield 72 may have a width that is approximately equal to the width of the recessed inner surfaces 44 and the sharpened edge 46. The second wing 50 may have identical structure and profile as the first wing 42.

As shown in FIG. 4, the pipe slitting apparatus 18 may be formed from a single piece with the first wing 42 and second wing 50 integrally formed with the body 34. Of course, one skilled in the an will appreciate that the wings may be welded to the body or fastened in an alternative way to allow for replacement of the wings if they become damaged or break. The hollow region 40 of the body has a cross-sectional profile that is larger than the cross-section profile of the wire rope 12. This permits the wire rope 12 to be partially contained within the hollow region 40 of the body 34 and allows for movement of the apparatus 18 along the wire rope during operation.

The first end 36 of the body guides the apparatus 18 into the old pipe 10. Accordingly, the first end 36 of the body 34 has an outer cross-sectional profile that is smaller than the inner diameter of the old pipe. The first end 36 of the body 34 may have a circumferentially tapered outer profile 60 configured to guide the body into the old pipe 10. The second end 38 of the body 34 has a larger outer cross-sectional profile than the first end 36. The larger outer profile helps to separate the cut halves of the old pipe and pushes the old pipe into the surrounding soil. As shown in FIG. 4, the second end has a tapered internal profile 62 to receive a rounded nose 64 (FIG. 5) of the expander 14 (FIG. 5). The rounded nose 64 and tapered internal profile 62 permit the expander to pivot slightly relative the apparatus 18 to permit the system to pull the new pipe 30 into the ground through slight curves.

Turning now to FIGS. 1 and 5, the expander 14 comprises a tapered, or frustoconical section 74, a jam nut 76, and a clevis 78. The frustoconical section 74 increases in cross-sectional area from the nose 64 of the expander to the rear 80 of section 74. The rear 80 of the frustoconical section is preferably of greater cross-sectional area than the cross-sectional area of the old pipe 10; such that the bore left behind following advancement of the expander has a cross-sectional profile is larger than the old pipe. The clevis 78 is attached to the replacement pipe connector 16 (FIG. 1) by a connector 82. The connector 82 may be a threaded bolt. The clevis 78 may rotate relative to the frustoconical section 74. The jam nut 76 is rotationally connected to the clevis 78 and may be threaded into the frustoconical section 74.

As shown in FIG. 5, the expander 14 also has a swivel bolt 84 and a gripper 86. The swivel bolt 84 is threaded into the clevis 78 and allows the clevis to rotate relative to the jam nut 76 and frustoconical section 74. Therefore, relative rotation between the replacement pipe connector 16 (and therefore the new pipe 30) and wire rope 12 is allowed. The gripper 86 may comprise jaws that are disposed inside the frustoconical section 74 within a tapered hollow region 88 and about the wire rope 12. The jaws 86 are movable between a first position and a second position. In the first position, as shown in FIG. 5, the jaws 86 are engaged with the wire rope 12 such that the wire rope is held in place axially relative the expander 14. In the second position (not shown), the jaws 86 are withdrawn from the tapered hollow region 88 and do not engage the wire rope 12. A rear interior portion of the frustoconical section 74 comprises threads 90 that mate with lands 92 on the exterior of the jam nut 76. Alternatively, jam nut 76 and the frustoconical section 74 may connect through a bolted, fused, quick-attach or other known connection method.

As the jam nut 76 is threaded into the frustoconical section 74, the nut engages thrust washer 96 and pushes the jaws 86 into the tapered hollow region 88 to grip the wire rope 12. The action of tightening jam nut 76 couples the expander 14 to the wire rope 12 and permits the entire assembly to be towed through the ground. The expander 14 is connected to a towing eye 98 of the replacement pipe connector 16 by the clevis 78 and bolt 82.

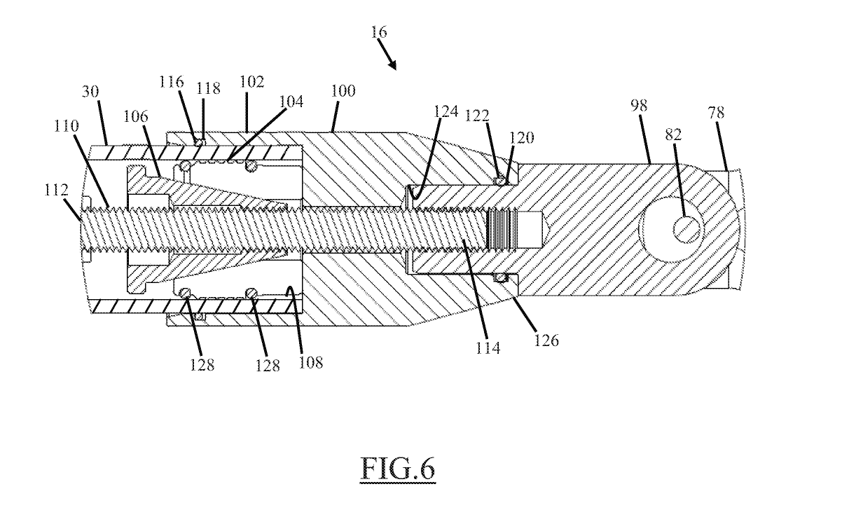

Turning now to FIG. 6, the replacement pipe connector 16 is shown. The replacement pipe connector 16 comprises a body 100, a sleeve 102, a set of puller jaws 104, a cone 106, a hollow region 108 defined by the space between the jaws and the sleeve, and a threaded shaft 110. The threaded shaft 110 is attached to an eyelet (not shown) on a first end 112 and the towing eye 98 on a second end 114. The threaded shaft 110 extends through the body 100 and is threadedly engaged with the cone 106. The puller jaws 104 are disposed about the cone 106 and threaded shaft 110 within the hollow region 108. As the cone 106 is moved along the threaded shaft 110 toward the second end 114, the puller jaws 104 expand outward within the hollow region 108 toward the sleeve 102 to grip the new pipe 30 between the jaws and the sleeve. Rotation of the threaded shaft 110 while the cone 106 is rotationally fixed to the puller jaws 104 causes the jaws to expand or contract, depending on the direction of thread and rotation. Further, pulling the threaded shaft 110 toward the expander 14 will similarly cause the puller jaws 104 to expand toward the sleeve 102.

The new pipe 30 is attached to the replacement pipe connector 16 by placing the new pipe within the hollow region 108 and expanding the puller jaws 104 through use of the threaded shaft 110 as described above. Clamping force between the puller jaws 104 and sleeve 102 may hold the new pipe 30 in place. Alternatively, an adaptor (not shown) may be used to connect the replacement pipe connector 16 to the new pipe, or the new pipe may be fused to the replacement pipe connector

An O-ring 116 may be placed within seal groove 118 to seal the hollow region 108 from debris or other materials present during the replacement operation. Likewise, a second O-ring 120 may be placed within a seal groove 122 formed in the body 100 of the replacement pipe connector 16 to seal the hollow region 124 proximate the nose 126 of the replacement pipe connector 16. O-ring 122 decreases the likelihood of debris entering the hollow region 124 through the space between towing eye 98 and body 100. O-rings 128 are disposed between the jaws 104 and the new pipe 30 and act as circumferential springs that collapse jaws 104 in position when not engaged with the new pipe.

In operation, the wire rope 12 is fed axially through the old pipe 10 from the entry pit 28 to an exit point. The wire rope 12 is threaded through the hollow region 40 of the pipe slitting apparatus 16. The wire rope 12 is then also threaded through the hollow region 88 of the expander and secured to the expander with jam nut 76 and jaws 86. The new pipe 30 is connected to the replacement pipe connector 16 by rotating the threaded shaft 110 to pull the cone 106 toward the second end 114 of the shaft. This causes jaws 104 to expend and grip the new pipe between the jaws and the sleeve 102.

With the new pipe 30 secured within the replacement pipe connector 16, the towing eye 98 is threaded onto the second end of the threaded shaft 110 and pivotally connected to the clevis 78 with bold 82.

Once assembled, the rope puller 20 is engaged to pull the wire rope 12 and the pipe slitting apparatus toward the entry pit 28. As the pipe slitting apparatus 18 is advanced through the old pipe 10 the sharpened edges 46 and 56 on the first 42 and second 50 wings, respectively slit the old pipe 10 into two halves The body 34 and expander 14 push the old pipe outward into the soil surrounding the expander and the new pipe 30 is towed into the bore left behind. When the new pipe 30 reaches the entry pit 28 the replacement pipe connector 16, expander 14, and pipe slitting apparatus 18 are removed from the new pipe.

One of ordinary skill in the art will appreciate that while the figures show one configuration for the subject invention, modifications to the particular shape and organization of the pipe slitting apparatus 18 may be taken without departing from the spirit of the disclosed invention. For example, the slitting apparatus 18 may be integrally formed with the expander 14 rather than abutting the nose 64 of the expander. Likewise, the replacement pipe connector 16 may be integrally formed rather than connected to the expander at a clevis joint.

What is claimed is:

1. An assembly comprising:
an elongate body having opposed first and second ends and a hollow region extending end-to-end; and
a first wing supported on the body comprising:
a recessed inner surface having a sharpened edge; and
an outer surface having no edge as sharp as the sharpened edge of the recessed inner surface.

2. The assembly of claim 1 in which the recessed inner surface is concave.

3. The assembly of claim 1 in which the wing radially projects from the body.

4. The assembly of claim 2 in which the concave recessed inner surface opens toward the first end of the body.

5. The assembly of claim 1 in which the first end of the body has a cross-sectional profile that is smaller than that of the second end.

6. The assembly of claim 1 in which a second wing is supported on the body.

7. The assembly of claim 6 in which the body is symmetric about a longitudinal axis and in which the first and second wings are offset by a central angle of 180 degrees.

8. The assembly of claim 1 in which a wire rope is partially contained within the hollow region of the body.

9. The assembly of claim 1 wherein the first end of the body has a tapered outer profile configured to guide the body into a pipe.

10. The assembly of claim 1 wherein the first wing is one of a plurality of wings that project radially from the body.

11. The assembly of claim 10 in which the body is symmetric about a longitudinal axis and in which the plurality of wings are uniformly spaced about the longitudinal axis.

12. A system comprising:
a wire rope having a first end and a second end;
an expander operatively engaged to the wire rope at its first end;
a rope puller operatively engaged to the wire rope at its second end; and
the assembly of claim 1, disposed on the wire rope between the expander and the rope puller.

13. The system of claim 12 further comprising a replacement pipe connector operatively engaged with the expander.

14. The system of claim 12 in which the wire rope is partially contained in the hollow region of the body.

15. The system of claim 14 in which the assembly is moveable along the wire rope relative to the expander.

16. The system of claim 12 in which a second wing is supported on the body.

17. The system of claim 12 in which the recessed inner surface is configured to form a cutting edge.

18. The system of claim 12 in which the expander has a fir t end and a second end, and in which the second end of the body has a tapered internal profile to receive the first end of the expander.

19. The system of claim 12 in which the first end of the body has a tapered outer profile configured to guide the body into a pipe.

20. An assembly comprising:
an elongate body having opposed first and second ends; and
a plurality of wings supported on the body, each wing comprising:
a recessed inner surface having a sharpened edge configured to cut a pipe; and
an outer surface having no edge as sharp as the sharpened edge of the inner surface.

21. The assembly of claim 20 in which the recessed inner surface is concave.

22. The assembly of claim 20 in which the body comprises a longitudinal axis and in which the plurality of wings are uniformly spaced about the longitudinal axis.
